(19) United States
(12) Patent Application Publication
(10) Pub. No.: US 2021/0169253 A1
(43) Pub. Date: Jun. 10, 2021

(54) CONDIMENT SEASONING CONTAINER COVER

(71) Applicant: Shameka Latoria Owens, Sandusky, OH (US)

(72) Inventor: Shameka Latoria Owens, Sandusky, OH (US)

(21) Appl. No.: 16/708,626

(22) Filed: Dec. 10, 2019

(51) Int. Cl. A47G 19/24; A47J 47/04

(52) U.S. Cl. CPC A47G 19/24; A47J 47/04

(57) ABSTRACT

This invention is used for sanitary purposes and will be a health barrier in restaurants and cooking facilities where the spreading of germs are caused by continuous public handling of the same article and when cross-contamination is at a high risk while cooking.

### FIELD OF THE INVENTION

This invention relates to protective coverings of condiment and food seasonings containers, in order to prevent and limit the amount of germs and cross-contamination done by customers while dining out, and individuals in any cooking facilities.

### BACKGROUND OF THE INVENTION

Germs can't be detected by the eye, but they still exist. Unfortunately, every time that you dine out or prepare food, germs are passed to every individual that wants to add additional seasoning to their food. In the restaurant setting, this is done by the handling of the condiment containers, that are available for everyones use and by cross-contamination when cooking in kitchen facilities. The issue with this, is that the previous customer was handling the condiment container, and nothing was present to prevent the germs that the customer has from being spread to the next customer that will be dining at the same table. While cooking the individual handles food and seasoning, sometimes simultaneously, thus causing cross-contamination of food and the seasoning containers.

### SUMMARY OF THE INVENTION

The purpose of this invention is to eliminate the spread of germs in public restaurants and cooking facilities. It can be used for sanitary issues and as a health barrier in public places. The advantage of this invention, is that it will lower the risk of you getting germs from the thousands of people that have dined there prior to your arrival. Its protection will protect the individual if they would have to handle the same article that the previous customer handled. Along with lowering the cross-contamination process while cooking.

DESCRIPTION OF DRAWINGS [0004 FIG. I [0005] This drawing illustrate a condiment seasoning cover protector that is 5 ⅛ inches in diameter by 3 ½ inches in height. Being that this plastic, it does not illustrate the adhesive or elastic band that can be used if made with different materials, which would be ⅝ from the top. The cover measures 3 inches from where the elastic band or glue would be, to the bottle of the comdiment seasoning cover protector. This cover is made of plastic, thus not needing any adhesive or elastic band, unlike if it was made with paper or cotton like material, which would need the adhesive and elastic band. [0006] FIG. II

This illustrates the opening cuts that will be made, in order to install the invention over the condiment container. Dimensions will vary depending on what article it is protecting.

FIG. III [0009] This illustrates a standard condiment container which has had the protector installed. [0010] FIG. IV [0011] This illustrates a seasoning container which has had the protector installed. [0012] FIG. V [0013] This illustrates the opening cuts that will be made, in order to install the invention over the seasoning container that will be used in the kitchen facilities. Dimensions will vary depending on what article it is protecting.

1. I, Shameka' La'Toria Owens claim that the condiment seasoning protectant covers will be used in restaurants where condiments are shared by the public and in kitchen cooking facilities when raw food is being handled simultaneously with seasonings that are packaged. This is for any condiment and seasoning containers that will be handled by multiple users where germs have not been eliminated.

### DESCRIPTION OF THE INVENTION

Condiment seasoning container covers can be produced in any material cover such as plastic, cotton fabric, paper, but not limited to any raw material that can take the shape to an object. Any and all material used, is for a one (1) time use, and must be disposed of, or washed following immediate use. This invention is for any and all condiments and seasoning containers, that are used in restaurant settings and any cooking facility. Covers will vary in dimension according to the item that is being handled. The sample cover is produced for a standard restaurant sized salt and pepper container which is 2 ¼ (height)×2 ¼ (diameter). Glue, an elastic ring, or nothing can be added ⅝ from the top for extra attachment, but is not needed in order for the invention to work properly.

1. A condiment seasoning container protectant comprising a plastic sleeve that covers the entire container in which an individuals hands will come into contact with.
